(19) United States
(12) Patent Application Publication
(10) Pub. No.: US 2009/0231120 A1
(43) Pub. Date: Sep. 17, 2009

(54) INTEGRATED APPARATUS FOR MEDICAL ALARM SYSTEM

(76) Inventor: Donny Chung, Taipei (TW)

Correspondence Address: HDLS Patent & Trademark Services, P.O. BOX 220746, CHANTILLY, VA, 20153-0746, US

(21) Appl. No.: 12/047,398

(22) Filed: Mar. 13, 2008

(51) Int. Cl. G08B 19/00

(52) U.S. Cl. 340/521; 340/632; 340/531

(57) ABSTRACT

An integrated apparatus for a medical alarm system includes modules and functions of both area alarm units and master alarm units. An input/output module is provided to specify functions of the area alarm units and master alarm units when the two functions are separately executed. In addition, functions of both area alarm units and the master alarm units can also be operated in an integrated apparatus. The execution programs of the integrated apparatus can be updated and modified by connecting the integrated apparatus to an external memory card. Therefore, the integrated apparatus saves not only disassembling and assembling time, but also costs of update operation.

### BACKGROUND OF THE INVENTION

1. Field of the invention

The present invention relates to an alarm, and more particularly to a medical alarm.

2. Description of the Prior Art

Recently with the rapid improvement of medical technique and equipment, not only the cure rate but also the average life is higher. Because excellent medical technique is based on powerful and stable medical equipment, improvement of the medical equipment has become more attentive.

In a hospital, there are many sickrooms used for treatment, operation, admission, or so on. Therefore, the environmental data of the sickrooms, such as the contents of oxygen, nitrogen, and nitrous oxide, or temperature, humidity, pressure, gas concentration, and so on are necessary to be monitored and analyzed to ensure medical safety for patients and medical personnel.

Reference is made to FIG. 1A and FIG. 1B, wherein the FIG. 1A is a block diagram of a prior art area alarm unit and the FIG. 1B is a block diagram of a prior art master alarm unit. Each of the area alarm units 10 is installed in each of the sickrooms, and a sensor 102 is used to detect various environmental data, such as the contents of oxygen, nitrogen, and nitrous oxide, or temperature, humidity, pressure, gas concentration, etc. Afterward, all of the area alarm units 10 are connected to the central master alarm unit 20, and the detected environmental data of the area alarm units 10 are integrated and delivered to the master alarm unit 20. Furthermore, the detected environmental data are instantaneously updated. A display 202 of the maser alarm 20 is used to display environmental information of all sickrooms; or an external host 3 can be connected to the master alarm unit 20 to collect and organize the detected environmental data. Therefore, supervisors can exactly monitor all sickrooms by the external host 3.

Because the area alarm unit 10 and the master alarm unit 20 are the different apparatuses, the prior art alarm system is lack of installation flexibility. In other word, the amount of the area alarm units 10 and the master alarm units 20 are proportional to the amount of the monitored sickrooms. For example, fifty area alarm units 10 are required to purchase for service of fifty monitored sickrooms, and the master alarm units 20 are purchased according to actual demand for integrating and monitoring the environmental data. Therefore, if the numbers of the monitored sickrooms, or the number of the area alarm units 10 and the master alarm units 20 need to change, the installation costs increase, otherwise the installation efficiency decreases. Furthermore, all execution programs are embedded in processors of both area alarm units 10 and master alarm units 20 before shipping from factories. When the execution programs of the area alarm units 10 or the master alarm units 20 need to be updated, inside circuit boards of the area alarm units 10 or the master alarm units 20 have to be taken apart to update the execution programs. Therefore, it is to spend not only disassembling and assembling time but also costs of update operation.

### SUMMARY OF THE INVENTION

It is a primary object of the present invention to provide an integrated apparatus of a medical alarm system so as to combine modules and functions of both area alarm units and master alarm units in the integrated apparatus. Therefore, the integrated apparatus can be used as an area alarm unit to detect environmental data in a sickroom or a master alarm unit to integrate detected environmental data in a monitor room. Furthermore, the integrated apparatus can also provide functions of an area alarm unit or a master alarm unit separately.

It is another object of the present invention to provide an integrated apparatus of a medical alarm system. A memory card module is installed in the integrated apparatus and connected to an external memory card with software programs to update and modify execution programs of the integrated apparatus. In addition, the memory card is used to copy stored data in the integrated apparatus to an external host so as to save not only disassembling and assembling time but also costs of updating the prior art circuit boards.

To achieve the objectives mentioned above, an integrated apparatus comprises modules and functions of both area alarm units and master alarm units. Furthermore, an input/output module is provided to distinguish functions of the area alarm units and the master alarm units. In addition, functions of both area alarm units and the master alarm units can also be operated in an integrated apparatus; and the execution programs of the integrated apparatus can be updated and modified by connecting to an external memory card.

It is to be understood that both the foregoing general description and the following detailed description are exemplary, and are intended to provide further explanation of the invention as claimed. Other advantages and features of the invention will be apparent from the following description, drawings and claims.

### BRIEF DESCRIPTION OF DRAWING

The above and further advantages of this invention may be better understood by referring to the following description, taken in conjunction with the accompanying drawings, in which:

FIG. 1A is a block diagram of a prior art area alarm unit;

FIG. 1B is a block diagram of a prior art master alarm unit;

FIG. 2 is an architecture block diagram of an integrated apparatus according to the present invention;

FIG. 3 is a schematic view of using the integrated apparatus; and

FIG. 4 is another schematic view showing application of the integrated apparatus.

FIG. 5 is an architecture block diagram of an integrated apparatus according to another preferred embodiment of the present invention;

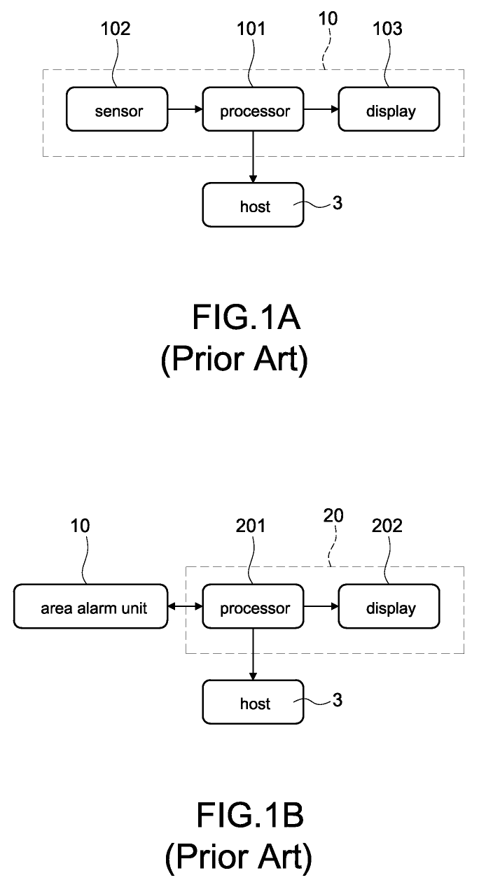

The drawings will be described further in connection with the following detailed description of the present invention.

### DETAILED DESCRIPTION OF THE INVENTION

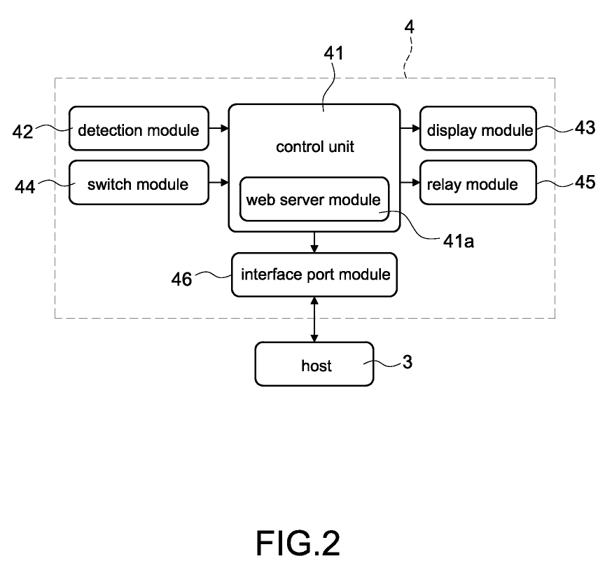

Reference is made to FIG. 2 which is an architecture block diagram of an integrated apparatus according to the present invention. The integrated apparatus comprises a control unit 41 with an embedded operating system and a plurality of modules. The functions of the prior art area alarm unit 10 and the master alarm unit 20 are also provided in a same apparatus by electrically connecting between the control unit 41 and each of the modules, namely, the integrated apparatus 4 provides the functions of both the prior art area alarm unit 10 and the master alarm unit 20. Hence, the control unit 41 can be, but not limited to, a central processing unit (CPU) with at least 32 bits. The plurality of modules comprises:

1. A detection module 42 is used to detect various environmental data, such as the contents of oxygen, nitrogen, and nitrous oxide, or temperature, humidity, pressure, gas concentration, etc., and the data are delivered to the control unit 41 to be analyzed whether which are up to the standards or not.

2. A display module 43 can be an organic light emitting diode (OLED), a light emitting diode (LED), a liquid crystal display (LCD), or so on. The display module 43 shows with different signs to indicate a normal or abnormal environmental condition according to the analyzed data.

3. A switch module 44 can be used to connect to various external extension apparatus 5 with a switch function, such as a vacuum sweeper, an air compressor, or so on. For example, the switch module 44 is installed in a second integrated apparatus 4b, which provides function of the master alarm unit, and is connected to the first integrated apparatus 4a, which provides function of the area alarm unit, to receive recorded alarm signals from the first integrated apparatus 4a.

4. A relay module 45 is used to connect to other apparatuses or circuit boards so as to deliver the alarm signals to other alarm systems or apparatuses. For example, the relay module 45 is installed in the first integrated apparatus 4a, which provides function of the area alarm unit, and is connected to the second integrated apparatus 4b, which provides function of the master alarm unit, to output sensed alarm signals by the detection module 42 of the first integrated apparatus 4a to the second integrated apparatus 4b.

5. A web server module 41a is embedded in the control unit 41 and used as an embedded web server. The web server module 41a can be updated by an external memory card to be monitored by the Internet.

The integrated apparatus 4 further comprises a interface port module 46 to connect to an external host 3 in a wired or wireless way to carefully monitor sickrooms in a hospital. In this embodiment, an RS-232 interface port provides the wired way, while a wireless LAN card provides the wireless way. The interface port module 46 can be used as an interface module, which supports the TCP/IP communication protocol, and can be connected to a personal computer so as to monitor environmental data on the personal computer by the web server module 41a.

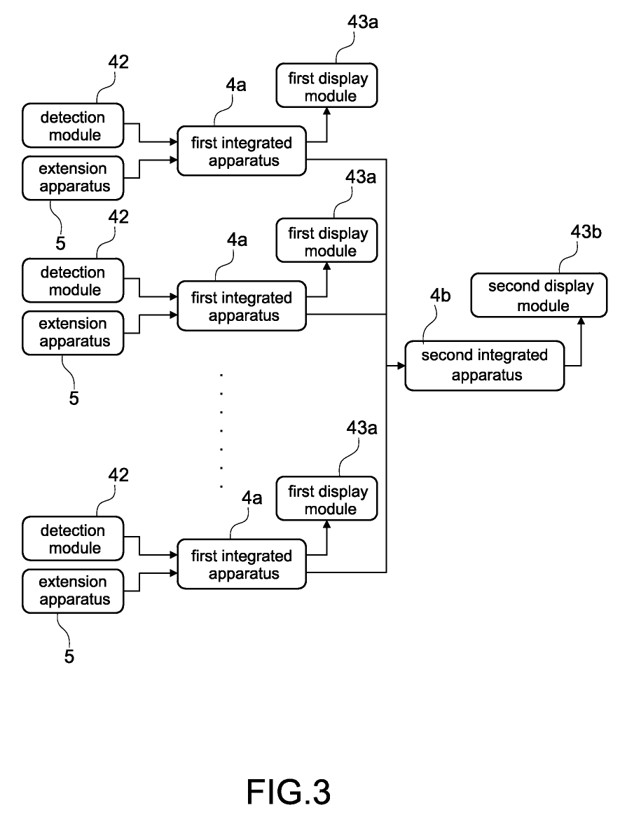

Reference is made to FIG. 3 which is a schematic view of using the integrated apparatus. A plurality of first integrated apparatus 4a (area alarm unit) are connected to a second integrated apparatus 4b (mater alarm). The plurality of first integrated apparatus 4a are placed in different sickrooms, respectively; and the second integrated apparatus 4b is placed in a central control room. Each detection module 42 of the first integrated apparatus 4a is provided to detect various environmental data and the detected environmental data are delivered to the first integrated apparatus 4a. The first integrated apparatus 4a can be connected to the external extension apparatus 5, such as a vacuum sweeper, an air compressor, etc. (not shown) by the switch module 44 to detect the environmental data. The detected data are also delivered to the control unit 41 of the first integrated apparatus 4a for analysis by the control unit 41; and then the analyzed data is delivered to the display module 43 for display.

The first integrated apparatus 4a is used as an extension apparatus by connecting a relay module 45 thereof to a switch module 44 of the second integrated apparatus 4b to deliver the detected environmental data. In this embodiment, the first integrated apparatus 4a is connected to the second integrated apparatus 4b by an RS-485 annunciator board. The plurality of first integrated apparatus 4a (area alarm unit) are placed in different sickrooms to detect various environmental data, respectively; and the second integrated apparatus 4b (master alarm unit) is placed in a central control room to connect to the first integrated apparatus 4a by a plurality of switch module 44. Afterward, the display module 43 of the second integrated apparatus 4b is provided to display required information of all sickrooms. In this embodiment, a green LED and a red LED of the display module 43 are corresponded to the first integrated apparatus 4a (area alarm unit), and are used to display a normal or an abnormal environmental condition separately. Furthermore, the relay module 45 of the second integrated apparatus 4b is also connected to an external apparatus, such as an alarm apparatus, or an auto-alarm apparatus, etc. (not shown) to provide a pluralistic and integrated monitor so as to enhance security of the hospital.

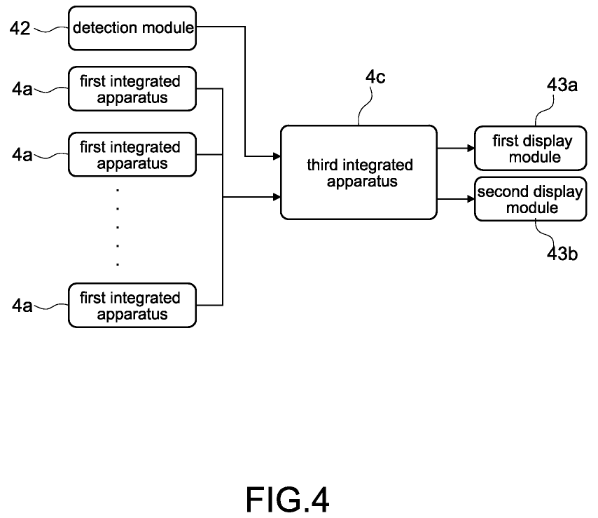

In addition, the integrated apparatus 4 provides not only function of the area alarm unit or the master alarm unit but also function of combining the two alarms together. Reference is made to FIG. 4 which is another schematic view showing application of the integrated apparatus. For example, five first integrated apparatuses 4a (area alarm unit) and one second integrated apparatus 4b (master alarm unit) are provided to monitor five sickrooms. However, one of the five first integrated apparatuses 4a simultaneously provides the functions of the area alarm unit and the master alarm unit because a real master alarm unit can be omitted. That is to say, a third integrated apparatus 4c is provided to detect environmental data and the detected data are displayed on a first display module 43a. The switch module 44 is used to receive environmental data from the four area alarm units installed in four different sickrooms. Therefore, the environmental data of all five sickrooms are delivered to the control unit 41 of the third integrated apparatus 4c for further processing. Afterward, the processed data of all five sickrooms are displayed on a second display module 43b.

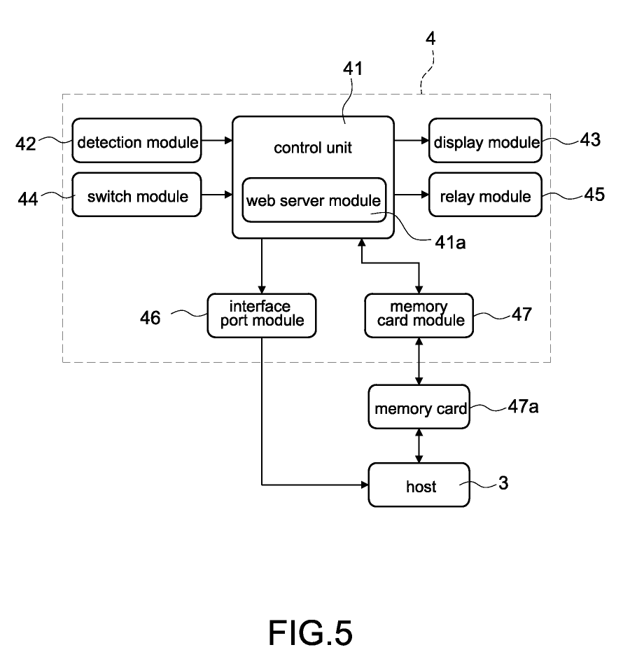

Three functions (the area alarm units, the master alarm units, and combination of the area alarm units and the masters) of the prevent invention can be specified by an update program; and the update program of the integrated apparatus 4 can be also modified. As shown in FIG. 5, a memory card module 47 can be a secure digital (SD) card module. For example, if the web server module 41a has update requirement, the update program is stored in the external memory card 47a and the external memory card 47a is connected to an external host 3. Afterward, the external memory card 47a is connected to the memory card module 47 of the integrated apparatus 4 so that the web server module 41 a can be updated by the external host 3. Therefore, a part of circuit board installed in the integrated apparatus 4 need not be taken apart from the integrated apparatus 4 before updating. Accordingly, not only disassembling and assembling time is reduced but also costs of updating the prior art circuit boards is reduced.

Although the present invention has been described with reference to the preferred embodiment thereof, it will be understood that the invention is not limited to the details thereof. Various substitutions and modifications have been suggested in the foregoing description, and others will occur to those of ordinary skill in the art. Therefore, all such substitutions and modifications are intended to be embraced within the scope of the invention as defined in the appended claims.

What is claimed is:

1. An integrated apparatus for a medical alarm system, comprising:
a control unit;
a detection module electrically connected to the control unit, and the detection module adapted for detecting various environmental data and delivering the detected environmental data to the control unit;
a switch module electrically connected to the control unit and used as an input module, and the switch module electrically connected to a first external apparatus and delivering instructions and data generated from the first external apparatus to the control unit;
a relay module electrically connected to the control unit and electrically connected to a second external apparatus and delivering instructions and data generated from the control unit to the second external apparatus;
a memory card module electrically connected to the control unit and connected to an external memory card, and the memory card module outputting the data stored in the control unit by the memory card, or updating execution programs of the control unit by software programs stored in the memory card;
a display module electrically connected to the control unit, and the display module receiving and displaying analyzed data delivered from the control unit.

2. The integrated apparatus in claim 1, wherein the control unit is a 32-bit central processing unit (CPU) with an embedded operating system.

3. The integrated apparatus in claim 1, wherein the detection module is a gas detection module, and the detection module is used to detect gas data and deliver the detected data to the control unit.

4. The integrated apparatus in claim 1, wherein both the first external apparatus and the second external apparatus are identical apparatuses.

5. The integrated apparatus in claim 1, wherein both the first external apparatus and the second external apparatus are implemented by the integrated apparatus.

6. The integrated apparatus in claim 1, wherein the switch module and the relay module have a plurality of dry contacts for connecting to the external apparatuses separately.

7. The integrated apparatus in claim 1, wherein the switch module and the relay module are electrically connected to the external apparatuses by RS-485 annunciator boards separately.

8. The integrated apparatus in claim 1, wherein the memory card module is a secure digital (SD) card module.

9. The integrated apparatus in claim 1, further comprising an interface port module electrically connected to the control unit, and the interface port module connecting to an external host so as to directly acquire the data stored in the integrated apparatus.

10. The integrated apparatus in claim 9, wherein the interface port module is connected to the external host by an RS-232 interface port.

11. The integrated apparatus in claim 9, wherein the interface port module is connected to the external host by a wireless LAN card.

12. The integrated apparatus in claim 1, wherein the display module is an organic light emitting diode (OLED).

13. The integrated apparatus in claim 1, wherein the display module is a light emitting diode (LED).

14. The integrated apparatus in claim 1, wherein the display module is a liquid crystal display (LCD).

15. The integrated apparatus in claim 1, wherein the control unit further comprises an embedded web server module.
